(19) United States
(12) Patent Application Publication
(10) Pub. No.: US 2013/0237647 A1
(43) Pub. Date: Sep. 12, 2013

(54) STRAW PLASTIC AND PREPARATION METHOD THEREOF

(71) Applicant: Zhengfu Yin, Yangzhou (CN)

(72) Inventor: Zhengfu Yin, Yangzhou (CN)

(73) Assignee: Jiangsu Jinhe Hi-Tech Co. Ltd, Yangzhou Jiangsu (JP)

(21) Appl. No.: 13/882,906

(22) PCT Filed: Apr. 22, 2011
(86) PCT No.: PCT/CN2011/073176

§ 371 Date: May 1, 2013

(30) Foreign Application Priority Data
Feb. 28, 2011 (JP) 201110047451.7

(51) Int. Cl. C08K 11/00; C08K 3/22; C08K 5/20

(52) U.S. Cl. CPC C08K 11/005; C08K 5/20; C08K 3/22
USPC 524/9; 264/211

(57) ABSTRACT

A straw plastic and the preparation method thereof are disclosed, wherein the crops straw with the length of 1.5˜2.0 mm is dried and mixed with plastic and plastic additive, and then extruded and palletized with twin screw extruder. The granular material of the invention has even particle size and stable state, and can be made into film, sheet or injection moulded product with molding process such as blow molding, drawing or injection molding. The product appears the color of natural wood, has the texture of plant fiber on the surface, and has good surface finish, high strength, good toughness, and comfortable hand feeling. The invention reduces the environmental pollution resulted from the discarding of undegradable plastic and achieves the full utilization of resource.

### FIELD OF THE INVENTION

The present invention relates to a plastic product, especially to a recovery processing technology of crop straw and the products thereof.

### BACKGROUND OF THE INVENTION

With the development of the plastics industry, plastics are applied widely in daily use, and the amount consumed is much higher and higher. As the plastics are mostly non-degradable, they consume the world's oil resources lot, and the wasters poison the environment seriously.

Crop straw is one kind of agricultural waste, it is usually burn. Burning not only wastes the potential value of the crop straw but also pollutes the air. The smog produced in the burning blocks the view, which causes security issues. The flame may also cause burns. The existing straw recovery processing is not yet ripe, so that the crop straw can not be fully utilized yet.

### SUMMARY OF THE INVENTION

The object of the present invention is to provide with a straw plastic to reduce environmental pollution caused by abandoning the non-degradable plastic and to collect and use the crop straw.

A straw plastic of the present invention comprising plastic, plastic additives and crop straw, the weight fraction of the plastic, the crop straw and the plastic additives is 63˜73%, 23˜33% and 4˜6% based on the total weight of the raw material.

The present invention can replace the conventional plastic, such as polypropylene, and it can be used to manufacture daily necessities such as dishware, containers, stationery and bags by blow film, drawing or injection molding. The processing temperature of the present invention can be reduced to 160˜180° C. for moulding, and the heat-resistance temperature of the present invention reaches to 80˜100° C., which satisfies the usual usage. The product appears the color of natural wood, has the texture of plant fiber on the surface, and has good surface finish, high strength, good toughness, and comfortable hand feeling. The invention reduces the environmental pollution resulted from the discarding of undegradable plastic and achieves the full utilization of resource.

The plastic of the present invention is any of polyethylene, polypropylene, polystyrene or acrylonitrile butadient styrene; the crop straw is any of rice straw, wheat straw, wheat bran, corn cop or corn stalk; the plastic additives are any of silane coupling agent, aluminate/titanate complexing coupling agent, stearic acid, ethylene bis stearamide, polyethylene wax, or titanium dioxide.

Another object of the present invention is to provide with a preparing method of straw plastic:

Mix the crop straw of 1.5˜2.0 mm in length after being dried, the plastic and the plastic additives, extrude the mixture into granules with a twin screw extruder; the weight fraction of the plastic, crop straw and additives is 63-73 wt %, 23-33 wt % and 4-6 wt % based on the total weight of raw material.

The straw plastic of the present invention is easily produced, and the granular material thereof has even particle size and stable state for further manufacturing. It needn't to renovate the old equipments. The present invention can be made into film, sheet or injection moulded product with molding process such as blow molding, drawing or injection molding.

### DETAILED DESCRIPTION OF THE EMBODIMENTS

### The First Embodiment (Injection Class Products)

1. Granulation

The crop straw is applied with rice straw, crush the rice straw to be scraps of 1.5˜2.0 mm in length, apply silane coupling agent and ethylene bis-stearomide as the plastic additives, mix with the polypropylene and extrude the mixture into granules with a twin screw extruder; when adding the material, the weight fraction of the rice straw, the silane coupling agent, the ethylene bis-stearomide and the polypropulene (or polystyrene) is 23˜33%, 1˜2%, 2˜3%, 63-73% based on the total weight of raw material.

2. Moulding

Heat the plastic granules to 160˜180° C. for injection moulding to produce injection parts.

### The Second Embodiment (Blow Film Products)

1. Granulation

The crop straw is applied with wheat straw and corn stalk, crush the wheat straw and corn stalk of 1000˜1200 mesh, apply aluminate/titanate complexing coupling agent, ethylene bis-stearomide and titanium dioxide as the plastic additives, mix with the polyethylene and extrude the mixture into granules with a twin screw extruder; when adding the material, the weight fraction of the wheat straw, the corn stalk, the alumniate/titanate complexing coupling agent, ethylene bis-stearomide, polyethylene wax and polyethylene is 10˜13%, 13˜20%, 1˜1.5%, 1˜1.5%, 2˜3%, 63˜73% based on the total weight of raw material.

2. Moulding

Heat the plastic granules to 160˜180° C. for blowing moulding to produce film products.

### The Third Embodiment (Drawing Class Products)

1. Granulation

The crop straw is applied with rice straw, wheat straw, corn cob, wheat bran, crush above crop straw into powder of 1000˜1200 in mesh, apply ethylene bis-stearomide and titanium dioxide as the plastic additives, mix with acrylonitrile butadient styrene and extrude the mixture into granules with a twin screw extruder; when adding the material, the weight fraction of the rice straw, the wheat straw, the corn cob, the wheat bran, the ethylene bis-stearomide, the titanium dioxide and the acrylonitrile butadient styrene is 5˜8%, 5˜8%, 5˜7%, 8˜10%, 1.5˜2%, 2˜4%, 63˜73% based on the total weight of raw material.

2. Moulding

Heat the plastic granules to 160˜180° C. for drawing moulding to produce sheet products.

### INDUSTRIAL APPLICABILITY

The present invention of a straw plastic and the preparing method thereof, the granular material of the present invention has even particle size and stable state, and can be made into film, sheet or injection moulded product with molding process such as blow molding, drawing or injection molding. The invention reduces the environmental pollution resulted from the discarding of non-degradable plastic and achieves the full utilization of resource.

What is claimed is:

1. A straw plastic, comprising plastic and plastic additives, wherein further comprising crop straw, the weight fraction of the plastic, the crop straw and the plastic additives is 63˜73%, 23˜33% and 4˜6% based on the total weight of the raw material.

2. A straw plastic according to claim 1, wherein the plastic is any of polyethylene, polypropylene, polystyrene or acrylonitrile butadient styrene.

3. A straw plastic according to claim 1, wherein the crop straw is any of rice straw, wheat straw, wheat bran, corn cop or corn stalk.

4. A straw plastic according to claim 1, wherein the plastic additives are any of silane coupling agent, aluminate/titanate complexing coupling agent, stearic acid, ethylene bis stearamide, polyethylene wax, or titanium dioxide.

5. A preparing method of straw plastic according to claim 1, wherein mix the crop straw of 1.5˜2.0 mm in length after being dried, the plastic and the plastic additives, extrude the mixture into granules with a twin screw extruder; the weight fraction of the plastic, crop straw and additives is 63-73 wt %, 23-33 wt % and 4-6 wt % based on the total weight of raw material.

6. A straw plastic according to claim 1, wherein the crop straw is applied with rice straw, crush the rice straw to be scraps of 1.5˜2.0 mm in length, apply silane coupling agent and ethylene bis-stearomide as the plastic additives, mix with the polypropylene and extrude the mixture into granules with a twin screw extruder; when adding the material, the weight fraction of the rice straw, the silane coupling agent, the ethylene bis-stearomide and the polypropulene is 23˜33%, 1˜1.5%, 3˜4.5%, 63-73% based on the total weight of raw material.

7. A straw plastic according to claim 1, wherein the crop straw is applied with wheat straw and corn stalk, crush the wheat straw and corn stalk of 1000˜1200 mesh, apply aluminate/titanate complexing coupling agent, ethylene bis-stearomide and titanium dioxide as the plastic additives, mix with the polyethylene and extrude the mixture into granules with a twin screw extruder; when adding the material, the weight fraction of the wheat straw, the corn stalk, the alumniate/titanate complexing coupling agent, ethylene bis-stearomide, polyethylene wax and polyethylene is 10˜13%, 13˜20%, 1˜1.5%, 1˜1.5%, 2˜3%, 63˜73% based on the total weight of raw material.

8. A straw plastic according to claim 1, wherein the crop straw is applied with rice straw, wheat straw, corn cob, wheat bran, crush above crop straw into powder of 1000˜1200 in mesh, apply ethylene bis-stearomide and titanium dioxide as the plastic additives, mix with acrylonitrile butadient styrene and extrude the mixture into granules with a twin screw extruder; when adding the material, the weight fraction of the rice straw, the wheat straw, the corn cob, the wheat bran, the ethylene bis-stearomide, the titanium dioxide and the acrylonitrile butadient styrene is 5˜8%, 5˜8%, 5˜7%, 8˜10%, 1.5˜2%, 2˜4%, 63˜73% based on the total weight of raw material.
